(19) United States
(12) Patent Application Publication
(10) Pub. No.: US 2012/0283995 A1
(43) Pub. Date: Nov. 8, 2012

(54) Method for Proposing a Layout of a High Concentration Photovoltaic System

(75) Inventors: Wan-Li Hsu, Taoyuan County (TW); Shang-Lee Chyou, Taoyuan County (TW); I-Tao Lung, Taoyuan County (TW)

(73) Assignee: ATOMIC ENERGY COUNCIL-INSTITUTE OF NUCLEAR ENERGY RESEARCH, Taoyuan County (TW)

(21) Appl. No.: 13/099,578

(22) Filed: May 3, 2011

(51) Int. Cl. G06F 17/50

(52) U.S. Cl. 703/1

(57) ABSTRACT

Disclosed is a method for proposing a layout of a high concentration photovoltaic system. At first, calculated is the area of land in which the high concentration photovoltaic system is to be deployed. Then, determined is a position for a solar tracking system. The track of the sun is determined. The operation of the solar tracking system is simulated. Pictures of the solar tracking system are taken. The shading rate of the solar tracking system is determined. The interval between two solar tracking activities is determined. The energy output of the photovoltaic system is determined.

### BACKGROUND OF INVENTION

1. Field of Invention

The present invention relates to a method for proposing a layout of a high concentration photovoltaic (“HCPV”) system and, more particularly, to a method for proposing a proper mode of construction of an HCPV system and, more particularly, to a method for proposing and illustrating a proper mode of construction of an HCPV system to achieve any given purpose.

2. Related Prior Art

Electricity is something that we need in everyday life. While we enjoy a comfortable style of life brought by the consumption of electricity, it seems only rational that we know impacts on the environment because of the generation of the electricity. Environmental protection is advocated around the world. Approaches to the environmental protection are addressed everywhere. Many governments make efforts to develop renewable energy to replace fossil fuel to reduce the release of the greenhouse gas, i.e., carbon dioxide, to alleviate global warming. Conventional ways for generation of electricity such as nuclear energy, hydraulic energy, fossil fuel impose impacts, more or less, on the environment. Therefore, efforts are made to develop renewable energy instead of the conventional energy. Renewable energy includes solar energy, wind power, biological energy and oceanic power. Solar energy seems to impose the least impacts on the environment among these forms of renewable energy. Solar energy is clean, i.e., it does not pollute the environment or produce the greenhouse gas. Hence, there is an on-going trend to build solar energy power plants to use solar energy.

It is still new engineering to build a high concentration photovoltaic (“HCPV”) power plant. It is a challenge to let designers, managers and investors know the benefits and risks of the construction of an HCPV power plant. From planning to operation of an HCPV power plant, there are plenty factors to be considered such as the position, capital and human resource.

For a conventional power plant such as a thermal power plant and a nuclear power plant, the design is based on 2-dimensional (“2D”) blueprints. To correct an error, it takes quite some time and wastes a lot of paper.

There is 3-dimensional (“3D”) animation to illustrate the planning of a power plant. There is however inadequate flexibility of design by 3D animation.

As mentioned above, the design of an HCPV power plant is based on 2D blueprints or 3D animation. However, for different needs about the capacity of the HCPV power plant and the gap between any two adjacent sun-tracking units 2 of the HCPV power plant, 2D blueprints or 3D animation must be remade, and this is exhausting.

The present invention is therefore intended to obviate or at least alleviate the problems encountered in prior art.

### SUMMARY OF INVENTION

It is an objective of the present invention to provide a method for proposing an optimal flow for designing an HCPV power plant at an stage of planning the HCPV power plant to avoid errors, thus reducing time for designing the HCPV power plant, and reducing money for constructing the HCPV power plant, and increasing the efficiency for constructing the HCPV power plant.

It is another objective of the present invention to provide a method for proposing and illustrating a proper mode of construction of an HCPV system to achieve any given purpose to avoid errors, thus reducing time for designing the HCPV power plant, and reducing money for constructing the HCPV power plant, and increasing the efficiency for constructing the HCPV power plant.

It is another objective of the present invention to provide an interactive platform based on techniques of virtual reality for developing virtual reality images and designing visualized dynamic simulated systems.

To achieve the foregoing objectives, the method includes the step of calculating the area of a piece of land after receiving dimensions of the land, the step of determining the positions of sun-tracking units after receiving the number of the sun-tracking units and an initial value of the gap between any two adjacent ones of the sun-tracking units, the step of determining the track of the sun with respect to the earth according to a sun track algorithm after receiving a year, month, date, starting point of time, ending point of time, longitude and latitude is provided, the step of simulating the operation of the sun-tracking units after receiving an initial value of an allowable shading rate of the sun-tracking units, wherein based on the track of the sun with respect to the earth, the angle of the sun-tracking units is calculated and the operation of the sun-tracking units is simulated, the step of providing images of the sun-tracking units and storing the images as image files, the step of determining the shading rate of the sun-tracking units by reading an image file of the shading of the sun-tracking units, finding and adding up the color of white and the color of gray, and dividing the sum by the color of gray, the step of determining the gap between any two adjacent ones of the sun-tracking units, wherein the calculated value of the shading rate is subtracted by 1 and the process is returned to the step of determining the positions of sun-tracking units if the calculated value of the shading rate is larger than the initial value of the shading rate, wherein the calculation is stopped if the calculated value of the shading rate is smaller than the initial value of the shading rate, and the step of estimating the capacity of the HCPV power plant based on the final value of the shading rate.

In an aspect, the track of the sun with respect to the earth is determined according to a sun track algorithm, and the operation of the sun-tracking units is simulated based on the track of the sun with respect to the earth.

In another aspect, the land and the sun-tracking units are depicted by a 3D drafting software program. The 3D drafting software program may be 3D Studio MAX.

In another aspect, the steps of calculating, determining, simulating and estimating are based on a virtual reality software program. The virtual reality software program may be Virtools.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of a method for proposing a layout of an HCPV power plant according to the preferred embodiment of the present invention;

FIG. 2 is a perspective view of an array of HCPV units of an HCPV power plant designed according to the method shown in FIG. 1; and

FIG. 3 is a perspective view of the array of HCPV units shown in FIG. 2 together with some estimated data related to the operation of the HCPV units.

### DETAILED DESCRIPTION OF PREFERRED EMBODIMENT

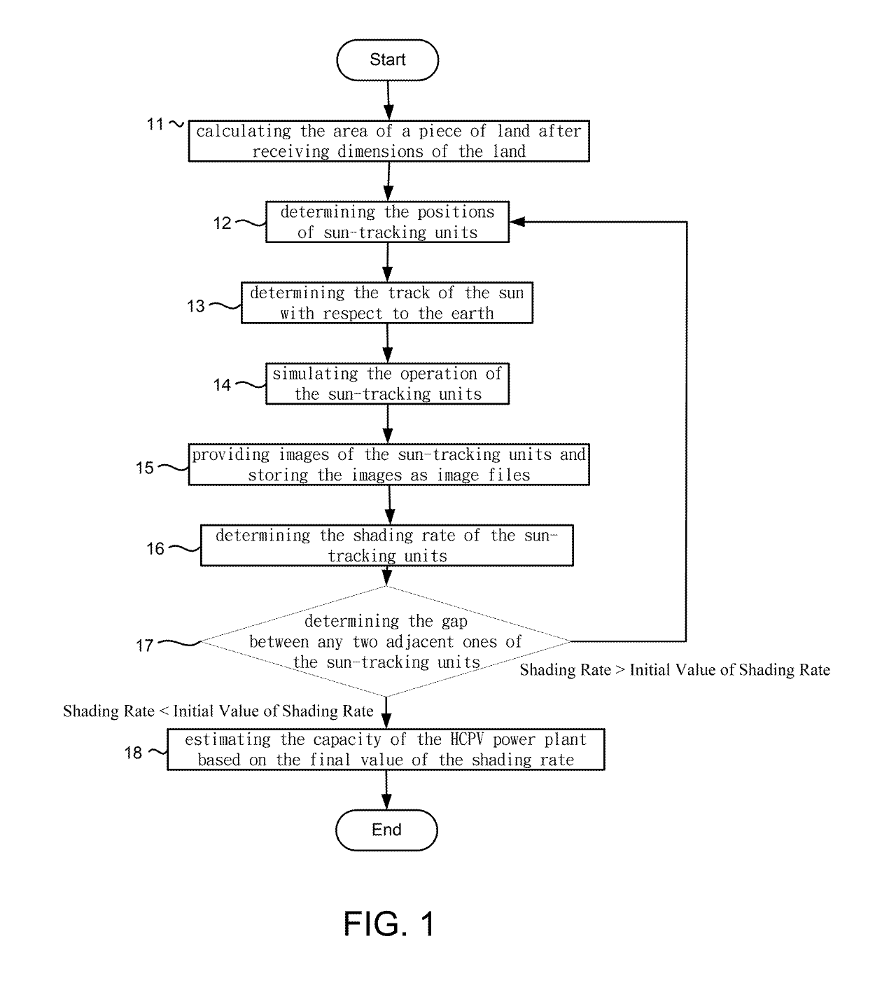

Referring to FIGS. 1 through 3, there is shown a method for proposing a layout of an HCPV power plant according to the preferred embodiment of the present invention. At 11, the area of a piece of land 1 where an HCPV power plant is to be constructed is calculated. To this end, there are provided dimensions of the land 1 such as length and width. The area is calculated based on the dimensions. The area is shown on a display.

At 12, the positions of sun-tracking units 2 are determined. To this end, the number of the sun-tracking units 2 and an initial value of the gap between any two adjacent ones of the sun-tracking units 2 are provided. The positions of the sun-tracking units 2 are calculated based on the number of the sun-tracking units 2 and the initial value of the gap between any two adjacent ones of the sun-tracking units 2.

At 13, the track of the sun with respect to the earth is determined. To this end, a year, month, date, starting point of time, ending point of time, longitude and latitude is provided. According to a sun track algorithm, the track of the sun with respect to the earth is calculated based on the year, month, date, starting point of time, ending point of time, longitude and latitude. The track of the sun with respect to the earth changes with the time and the location of the HCPV power plant.

At 14, the operation of the sun-tracking units 2 is simulated. To this end, an initial value of an allowable shading rate of the HCPV power plant is provided. Based on the track of the sun with respect to the earth, the angle of the sun-tracking units 2 is determined and the operation of the sun-tracking units 2 is simulated.

At 15, images of the sun-tracking units 2 are provided. To this end, after the simulation of the operation of the sun-tracking units 2, the images of the sun-tracking units 2 are provided and stored as image files.

At 16, the shading rate of the sun-tracking units 2 is determined. To this end, an image file of the shading of the sun-tracking units 2 is read. According to an image identification algorithm, the color of white and the color of gray are found and added up. Then, the sum is divided by the color of gray to determine the shading rate of the sun-tracking units 2.

At 17, the gap between any two adjacent ones of the sun-tracking units 2 is determined. If the calculated value of the shading rate is larger than the initial value of the shading rate, the calculated value of the shading rate is subtracted by 1, and the process is returned to 12 so that the positions of the sun-tracking are calculated again and shown on the display. These steps are repeated until the calculated value of the shading rate is smaller than the initial value.

At 18, the capacity of the HCPV power plant is estimated. To this end, the capacity of the HCPV power plant is calculated based on the final value of the shading rate.

The images of the land and sun-tracking units 2 are depicted with a 3D software program such as 3D Studio MAX.

The calculation, the determining, the presentation of the images, the simulation of the operation and the estimation are preferably conducted with a virtual reality software program such as Virtools.

In the method according to the present invention, a layout of the HCPV power plant is proposed in two manners, e.g., 3D images and words. That is, a user can see 3D images of the simulation of the operation of the HCPV power plant at different points of time and with different gaps between any two adjacent ones of the sun-tracking units 2. Alternatively, the user can read words related to proposed positions of the sun-tracking units 2.

As described above, the method according to the present invention satisfies the need of the user and let the user know the different states of the HCPV power plant at different points of time and in different zones.

For example, 3D Studio MAX is used to provide 3D objects corresponding to a piece of land 1 and an array of sun-tracking units 2 for a 5 kW HCPV power plant. The 3D images are sent to Virtools. Virtools is used to provide a user/device interface that shows the area of the land 1, the number of the sun-tracking units 2, the tracks of the sun relative to the earth (based on the time, longitude and latitude) and the shading rate. The method for proposing a layout of an HCPV power plant will be described.

At 11, the area of a piece of land 1 is calculated based on dimensions of the land 1 such as length and width.

At 12, the order and positions of the sun-tracking units 2 are determined based on the number of rows of the sun-tracking units 2 and the number of columns of the sun-tracking units 2.

At 13, the track of the sun with respect to the earth is determined. To this end, a year, month, date, starting point of time, ending point of time, longitude and latitude is provided. According to an algorithm, the track of the sun with respect to the earth is calculated based on the year, month, date, starting point of time, ending point of time, longitude and latitude. The position and angle of elevation of the sun relative to the earth at the given point of time can be known.

At 14, the operation of the sun-tracking units 2 is simulated. To this end, an initial value of an allowable shading rate of the HCPV power plant is provided. Based on the track of the sun with respect to the earth, the angle of the sun-tracking units 2 is determined and the operation of the sun-tracking units 2 is simulated. For every 3 minutes, the status of the sun-tracking units 2 is shown.

At 15, images of the sun-tracking units 2 are provided. After the simulation of the operation of the sun-tracking units 2, the images of the sun-tracking units 2 are provided and stored as image files.

At 16, the shading rate of the sun-tracking units 2 is determined. To this end, an image file of the shading of the sun-tracking units 2 is read. According to an image identification algorithm, the color of white and the color of gray are found and added up. Then, the sum is divided by the color of gray to determine the shading rate of the sun-tracking units 2.

At 17, the gap between any two adjacent ones of the sun-tracking units 2 is determined. If the calculated value of the shading rate is larger than the initial value of the shading rate, the calculated value of the shading rate is subtracted by 1, and the process is returned to 12 so that the positions of the sun-tracking are calculated again and shown on the display. These steps are repeated until the calculated value of the shading rate is smaller than the initial value.

At 18, the capacity of the HCPV power plant is estimated based on the final value of the shading rate. An estimate capacity of the HCPV power plant is obtained by subtracting a loss of capacity because of the shading rate of the sun-tracking units 2 from the total capacity.

3D objects of the land 1 and the sun-tracking units 2 can be merged and turned into a 3D image of the HCPV power plant. Then, various operative conditions such as the area, the number of the sun-tracking units 2 and the track of the sun with respect to the earth are entered so that the operation of the operation of the HCPV power plant is simulated and illustrated. Finally, in 3D images or tables, a layout of the HCPV is proposed.

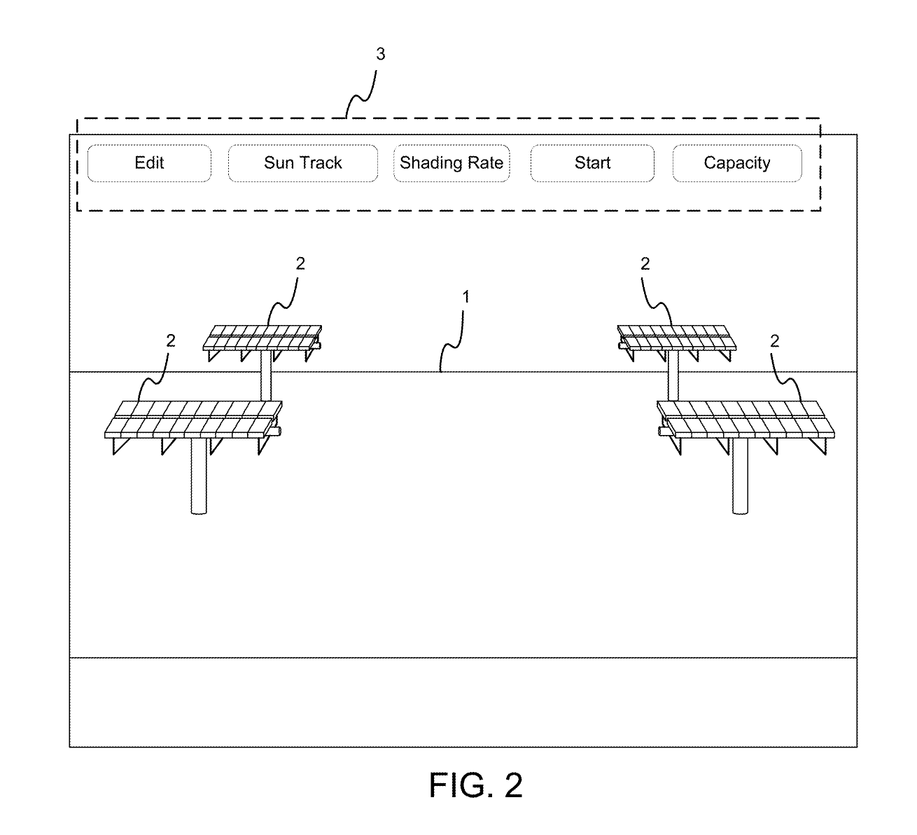

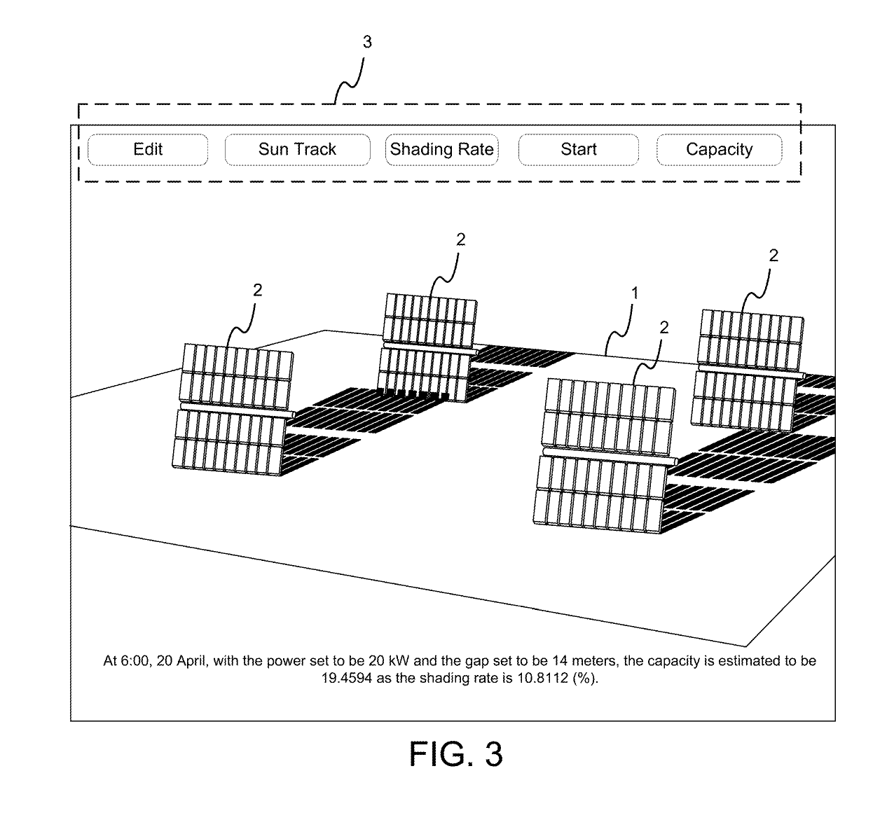

Referring to FIGS. 2 and 3, it is assumed that the capacity of the HCPV power plant is 20 kW, and the point of time is 6:00 AM, 20 Apr. 2010, and the initial value of the gap between any two adjacent ones of the sun-tracking units 2 is 16 meters, and the allowable shading rate of the HCPV power plant is 12%. At first, a scene of the HCPV power plant is set. In a screen 3 of the user/device interface, the method is executed as follows:
1. Enter the dimensions of the land 1: the length is 500 cm and the width is 500 cm;
2. Enter the data of the sun-tracking units 2: the sun-tracking units 2 are arranged in a 2×2 array, and the initial value of the gap is 16 meters;
3. Enter a position of the HCPV power plant and a point of time related to the track of the sun with respect to the earth: the point of time is 6:00 AM, 20 Apr. 2010, and the zone is E121 15, N24 51;
4. Enter the allowable shading rate of the HCPV power plant: 12%;
5. Click the “Start” icon in a screen 3 to initialize the simulation: the simulation of the operation of the HCPV power plant is based on the angle of the sun-tracking units 2, and the angle of the sun-tracking units 2 is based on the track of the sun with respect to the earth;
6. Calculate the shading rate of the sun-tracking units 2 once and again until the calculated shading rate is lower than 12%; and
7. Click the “Estimate the capacity” icon in the screen 3, and the capacity is estimated to be 19.4594 kW at 6:00 AM 20 Apr. 2010, and the gap is 14 meters, and the shading rate is 10.8112%.

In the above-mentioned embodiment of the present invention, the shading rate of the sun-tracking units 2 and the capacity of the HCPV power plant are determined based on the season, the time and the gap. In practice, shading causes more problems in the dawn and evening when the elevation angle is small than at noon when the elevation angle is large. Referring to FIG. 2, because of the large elevation angle, the sun is high above the sun-tracking units 2 so that the shading of a sun-tracking unit does not affect another sun-tracking unit.

As discussed above, two software programs, 3D Studio MAX and Virtools, are used to develop the method for proposing a layout of a HCPV power plant of the present invention. In an era of speed and efficiency, mature techniques of virtual reality are used to provide 3D images to simulate the operation of the HCPV power plant, thus proposing at least one layout for the HCPV power plant. The result of the construction of the HCPB power plant is predicted before the construction. The operation of the HCPB power plant is foreseen based on the track of the sun. The optimal layout of the HCPV is proposed. The capacity of the HCPV is predicted. Precautions are taken against accidents in the operation of the HCPV power plant.

The method of the present invention exhibits several advantages as follows:

First of all, it provides the 3D images of the simulation of the operation of the HCPV power plant according to the operative conditions entered by the user. The operative conditions entered by the user can be shown quickly to provide an interaction between the system and the user. For example, the user can know how to arrange the sun-tracking units 2 and how the shading of a sun-tracking unit affect the operation of another sun-tracking unit by entering different operative conditions and observing 3D images correspond to the operative conditions.

Secondly, it uses virtual reality instead of 3D and 2D designing. It enables the user to see 3D images of the simulation of the operation of the HCPV power plant to be constructed. It enables the user to review at least one proposed layout of the HCPV power plant and plan the HCPV power plant. Thus, conventional designing tools are replaced, and time, money and human resource are saved, thus reducing risks of decision-making and maximizing economic gains.

The method for proposing a layout of a HCPV power plant is novel and inventive for reasons as follows:

Regarding the novelty, there has not been any software program for planning a HCPV power plant. The method of the present invention is novel and enables the user to customize a HCPV power plant.

Regarding the inventiveness, there has not been any discussion about or even suggestion of the use of the virtual reality to prose the optimal layout of a HCPV power plant. The method of the present invention enables the user to predict the optimal layout through the calculation of the shading rate of the sun-tracking units 2 and the calculation of the track of the sun with respect to the earth and show the optimal layout with Virtools.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for proposing a layout of a high concentration photovoltaic power plant including the steps of:
calculating the area of a piece of land after receiving dimensions of the land;
determining the positions of sun-tracking units after receiving the number of the sun-tracking units and an initial value of the gap between any two adjacent ones of the sun-tracking units;
determining the track of the sun with respect to the earth according to a sun track algorithm after receiving a year, month, date, starting point of time, ending point of time, longitude and latitude is provided;
simulating the operation of the sun-tracking units after receiving an initial value of an allowable shading rate of the sun-tracking units, wherein based on the track of the sun with respect to the earth, the angle of the sun-tracking units is calculated and the operation of the sun-tracking units is simulated;
providing images of the sun-tracking units and storing the images as image files;
determining the shading rate of the sun-tracking units by reading an image file of the shading of the sun-tracking units, finding and adding up the color of white and the color of gray, and dividing the sum by the color of gray;
determining the gap between any two adjacent ones of the sun-tracking units, wherein the calculated value of the shading rate is subtracted by 1 and the process is returned to the step of determining the positions of sun-tracking units if the calculated value of the shading rate is larger than the initial value of the shading rate, wherein the calculation is stopped if the calculated value of the shading rate is smaller than the initial value of the shading rate; and
estimating the capacity of the HCPV power plant based on the final value of the shading rate.

2. The method according to claim 1, wherein the track of the sun with respect to the earth is determined according to a sun track algorithm, and the operation of the sun-tracking units is simulated based on the track of the sun with respect to the earth.

3. The method according to claim 1, wherein the land and the sun-tracking units are depicted by a 3D drafting software program.

4. The method according to claim 3, wherein the 3D drafting software program is 3D Studio MAX.

5. The method according to claim 1, wherein the steps of calculating, determining, simulating and estimating are based on a virtual reality software program.

6. The method according to claim 5, wherein the virtual reality software program is Virtools.
